(19) United States
(12) Patent Application Publication
(10) Pub. No.: US 2026/0298645 A1
(43) Pub. Date: Oct. 1, 2026

(54) METHOD AND SYSTEM FOR PROMPTING USERS TO NAVIGATE BASED ON CONNECTION TO TELECOMMUNICATION NETWORK

(71) Applicant: HCL Technologies Limited, New Delhi (IN)

(72) Inventor: Ganesh Parthasarathy, Chennai (IN)

(21) Appl. No.: 19/342,729

(22) Filed: Sep. 29, 2025

(30) Foreign Application Priority Data
Mar. 25, 2025 (IN) 202511027685

(51) Int. Cl. G01C 21/34; H04W 64/00

(52) U.S. Cl. CPC G01C 21/3453; H04W 64/00

(57) ABSTRACT

Method and system for prompting users to navigate based on connection to a telecommunication network are disclosed. Connection status of a user device is determined as one of: a connected state or a disconnected state, based on the connection of the user device to telecommunication network. Upon determining the connection status of the user-device as the disconnected state, one or more locations having signal strength of the telecommunication network above a predefined threshold are determined based on a network coverage map of the telecommunication network. A desired location is selected from one or more locations based on a predefined criterion. A set of instructions are output on an output device of the user device prompting the user to navigate to the desired location.

### DESCRIPTION

### Technical Field

This disclosure relates generally to navigation systems, and more particularly to method and system for prompting users to navigate based on connection to telecommunication network.

### BACKGROUND

Smart devices have become an integral part of lives today. Smart devices are being used for being connected and get things done faster and seamlessly. However, smart devices may be rendered redundant when not connected to a telecommunication network. Telecommunication networks have different signal strength and coverage at different locations based on network planning. Thus, signal strength of telecommunication networks vary from one location to another. However, lot of features of the smart device such as VoIP, data exchange, voice calls, and so on become unoperational at locations where the signal strength of a telecommunication network deteriorates or is not available. Further, users in emergency situations may feel helpless when they are unable to utilize their smart devices to connect to emergency services and cannot navigate themselved out of a location due to lack of signal.

Telecommunication networks tackle these problem by providing ways to handover the data connection. But sometimes handover may also not work in case of signal blindspots. Therefore there is a need of a system and methodology to securely navigate to a nearby location with signal availability.

### SUMMARY OF THE INVENTION

In one embodiment, a method for prompting a user to navigate based on connection to a telecommunication network is disclosed. In one example, the method may include determining, by a processor, a connection status of a user-device, based on a connection of the user-device to the telecommunication network, as one of: a connected state and a disconnected state. Upon determining the connection status of the user-device as the disconnected state, the method may further include determining, by the processor, one or more locations having a signal strength of the telecommunication network above a predefined threshold based on a network coverage map of the telecommunication network. It should be noted that the one or more locations may be determined in an area proximal to a current location of the user device. The method may further include selecting, by the processor, a desired location from the one or more locations based on a predefined criterion. The method may further include outputting, by the processor, a set of instructions on an output device of the user-device prompting the user to navigate to the desired location.

In one embodiment, a system for prompting a user to navigate based on a connection to a telecommunication network is disclosed. In one example the system may include a processor, and a computer-readable medium communicatively coupled to the processor. The computer-readable medium may store processor-executable instructions, which, on execution, may cause the processor to determine a connection status of a user device as one of: a connected state or a disconnected state, based on the connection of the user device to the telecommunication network. Upon determining the connected status as disconnected state, the processor-executable instructions, on execution, may further cause the processor to determine one or more locations having signal strength of the telecommunication network above a predefined threshold based on a network coverage map of the telecommunication network. The one or more locations may be determined in an area proximal to a current location of the user device. The processor-executable instructions, on execution, may further cause the processor to select a desired location from the one or more locations based on a predefined criterion. The processor-executable instructions, on execution, may further cause the processor to output a set of instructions on an output device of the user device prompting the user to navigate to the desired location.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for prompting users to navigate based on connection to telecommunication network.in accordance with some embodiments of the present disclosure.

FIG. 2 illustrates a functional block diagram of the computing device of FIG. 1, in accordance with some embodiments.

FIG. 3 illustrates a flow diagram of an exemplary process for prompting users to navigate based on connection to a telecommunication network, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims. Accordingly, the present disclosure provides a method and system for prompting users to navigate based on connection to a telecommunication network.

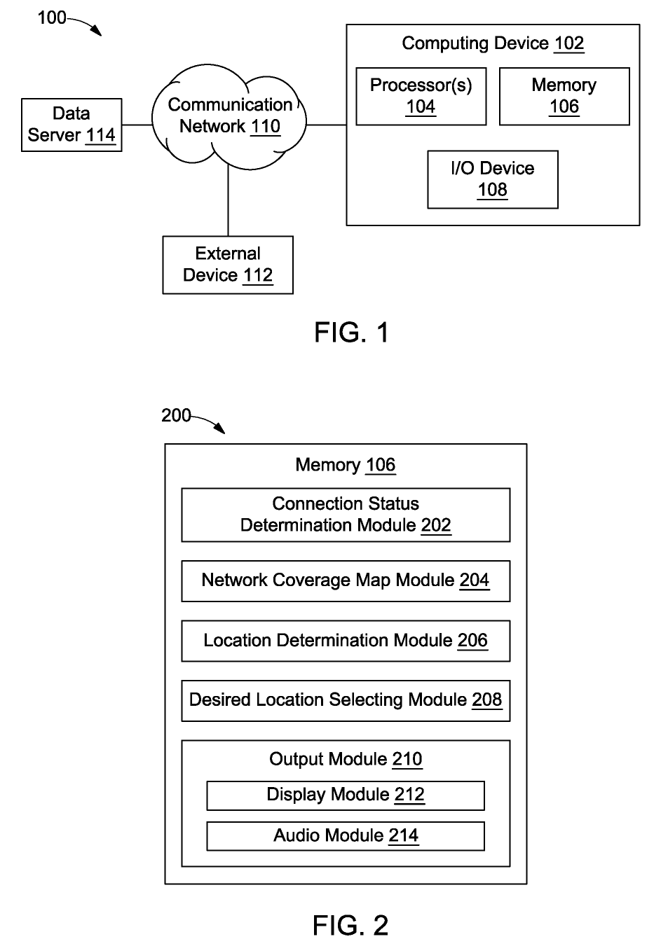

Referring now to FIG. 1, a block diagram of an exemplary block diagram of a system 100 for prompting users to navigate based on connection to a telecommunication network is illustrated, in accordance with an embodiment of the current disclosure. The system 100 may include a computing device 102, and a data server 112 communicably coupled to each other through a wireless communication network 110 (also referred to as telecommunication network). The computing device 102 (also referred to as “user device” may include a processor 104, a memory 106, and an input/output (I/O) device 108.

In an embodiment, examples of processor(s) 104 may include but are not limited to, an Intel^{®} Itanium^{®} or Itanium 2 processor(s), or AMD^{®} Opteron^{®} or Athlon MP^{®} processor(s), Motorola^{®} lines of processors, Nvidia^{®}, FortiSOC™ system on a chip processors or other future processors.

In an embodiment, the memory 106 may store instructions that, when executed by the processor 104, and cause the processor 104 to prompt users to navigate based on connection to a telecommunication network, as will be discussed in greater details herein below. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the computing device 102 may be, but not limited to, a standalone smart device for example, mobile phones, tablets, TVs, laptops, and the like. Further, the computing device 102 may include an I/O device 108. The I/O device 108 may include variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of input instructions and output results of data generated by various components such as, but not limited to, processor(s) 104 and memory 106.

In an embodiment, the data server 112 may be enabled in a remote cloud server or a co-located server and may include a database to store network coverage maps and other data necessary for the system 100 to prompt users to navigate based on connection to telecommunication network. In an embodiment, the computing device 102 may have a mobile application installed on it that may prompt users to navigate based on connection to a telecommunication network as discussed in detail in subsequent FIGs. In another embodiment, a webapp may be utilized by the computing device 102 that may optionally include one or more webpages that may be accessed by the user.

The web application may be developed using a variety of technologies such as HTML, CSS, JavaScript, and various web frameworks like React, Angular, or Vue.js. It may be hosted on a web server and accessible through standard web browsers. On the other hand, the software application may be a standalone program installed on the computing device 102 , which may be developed using programming languages such as Java, C++, Python, or any other suitable language depending on the platform. In an embodiment, the computing device 102 may be communicably coupled with the data server 112 through the communication network 110.

In an embodiment, the communication network 110 may be a wireless telecommunication network. The communication network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 110 can include a variety of network devices, including antennas, routers, bridges, servers, computing devices, storage devices, and the like.

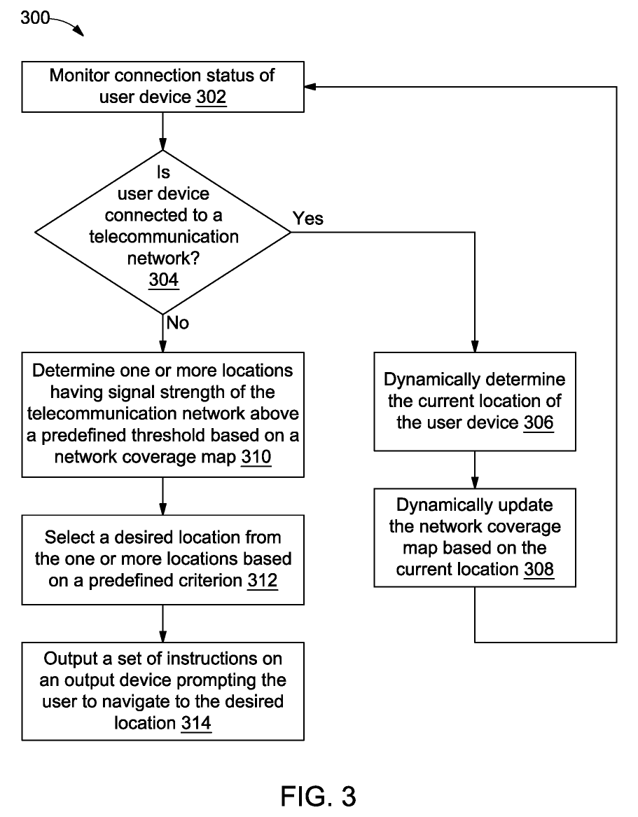

As will be described in greater detail in conjunction with FIGS. 2 – 3, the computing device 102 may determine its connection status based on connection to the telecommunication network, as one of a connected state or a disconnected state. Upon determining the connection status as disconnected state the computing device 102 may determine the one or more locations having signal strength of the telecommunication network above a predefined threshold based on a network coverage map of the telecommunication network. It may be noted that the one or more locations may be determined in an area proximal to a current location of the computing device 102. Further, the computing device 102 may select a desired location from the one or more locations based on a predefined criterion. The computing device 102 may then output a set of instructions on the I/O device 108 prompting a user to navigate to the desired location. Accordingly, the computing device 102 upon being disconnected from the telecommunication network may determine a desired location where the signals of the telecommunication network may be present. Further, it may prompt the user to navigate to the desired location in order for the connection status of the computing device 102 to be the connected state.

Referring now to FIG. 2, a functional block diagram of the computing device 102 of FIG. 1, in accordance with an embodiment of the present disclosure. In an embodiment, the computing device 102 may include within the memory 106, a connection status determination module 202, a network coverage map module 204, a location determination module 206, a desired location selecting module 208, and an output module 210. The output module 210 may further include a display module 212 and an audio module 214.

In an embodiment, a connection status determination module 202 may determine a connection status of the computing device 102 as one of a connected state and a disconnected state based on the connection of the computing device 102 to a telecommunication network. It may be noted that the connection of the computing device 102 to the telecommunication network may be determined based a signal strength received by a transceiver antenna of the computing device 102. In another embodiment, the connection status determination module 202 may determine the computing device 102 to be in a connected state in case a predefined signal strength is received by the computing device 102. Further, in case the computing device 102 receives signal below the predefined signal strength then the computing device 102 may be determined in a disconnected state.

It may be noted that when the computing device 102 is determined in the connected state, the network coverage map module 204 may dynamically determine a current location of the computing device 102 via at least one position determination system or methodology of the computing device 102. . In an embodiment, the position determination methodology may include cell tower triangulation, Wi-Fi location data, a global positioning system (GPS), an assisted GPS and/or by leveraging location history of the computing device 102. The network coverage map module 204 may dynamically update the network coverage map by fetching network coverage map from the data server 114 based on the determined current location of the computing device 102. It may be noted that the network coverage map for the telecommunication network to which the computing device 102 is connected and for an area that may include the current location of the computing device 102. It may be noted that that network coverage map module 204 may be dynamically updated after a predefined time interval or based on a trigger event. The trigger event may include, but not limited to, change in current location of the computing device 102 or change in telecommunication network provider to which the computing device 102 is connected, or deterioration of signal strength of the telecommunication network below a second predefined threshold level. It may be noted that the network coverage map may correspond to one or more telecommunication networks of which the computing device 102 may have an active subscription. The network coverage map may include a list of locations in which various bands of the telecommunication network that may be available at each of the locations.

Further, in case the connection status determination module 202 determines the connection status of the computing device 102 as the disconnected state, the location determination module 206 may determine one or more locations having a signal strength of the telecommunication network above a predefined threshold based on the network coverage map of the telecommunication network. It may be noted that the network coverage map that was previously fetched by the updated by the network coverage map module 204 may be utilized to determine one or more locations. Further, the one or more locations may be determined in an area proximal to the current location of the computing device 102 determined just before the connection status of the computing device 102 is determined as the disconnected state. It may be noted that the area proximal to the current location may be determined based on a predefined radius from the current location. In an example, the predefined radius may be, but not limited to, in a range of 200 m to 1 km. Accordingly, the location determination module 206 may determine one or more locations having signal strength more than the predefined signal strength within the predefined radius of the current location. In one embodiment, the location determination module 206 may determine a second current location of the computing device 102 after the computing device 102 has been determined in the disconnected state. The second current location may be determined by using a GPS of the computing device. The location determination module 206 may verify if the initial current location varies from the second current location. In case the second current location varies from the initial current location by a predefined threshold distance. Accordingly, the one or more locations may be determined in an area proximal to the second current location of the computing device 102 based on the network coverage map as discussed above.

The desired location selecting module 208 may cause the processor 104 to select a desired location from the one or more locations based on a predefined criterion. In one embodiment, the predefined criterion may include selecting the desired location from the one or more locations based on determination of a nearest navigable distance from the current location. In another embodiment, the predefined criterion may include a user selection of a desired location from the one or more locations. In case the second current location varies from the initial current location by a predefined threshold distance, the desired location from the one or more locations may be selected based on determination of a nearest navigable distance from the second current location.

The output module 210 may output a set of instructions on the I/O device 108 of the computing device 102 prompting the user to navigate to the desired location. The I/O device 108 may include a display module 212, displaying a map and the set of navigation instructions to navigate to the desired location. In an embodiment, the I/O device 108 may include the audio module 214 that may provide a set of audio instructions to the user to navigate to the desired location.

It should be noted that all such modules 202 – 210 may be represented as a single module or a combination of different modules. Further, as will be appreciated by those skilled in the art, each of the modules 202 – 210 may reside, in whole or in parts, on one device or multiple devices in communication with each other. In some embodiments, each of the modules 202 – 210 may be implemented as dedicated hardware circuit comprising custom application-specific integrated circuit (ASIC) or gate arrays, off-the-shelf semiconductors such as logic chips, transistors, or other discrete components. Each of the modules 202 – 210 may also be implemented in a programmable hardware device such as a field programmable gate array (FPGA), programmable array logic, programmable logic device, and so forth. Alternatively, each of the modules 202 – 210 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

Referring now to FIG. 3, an exemplary process 300 for prompting a user to navigate based on connection to a telecommunication network is depicted via a flowchart, in accordance with some embodiments of the present disclosure. The process 300 may be implemented by the processor 104 of the computing device 102 of the system 100. The process 300 may include at step 302 monitoring connection status of the computing device 102 by monitoring connection to a telecommunication network. The monitoring may include determining if the computing device 102 is connected to the telecommunication network or not. It may be noted that the connection status of the computing device 102 may be determined as one of: a connected state or a disconnected state based on the connection to the telecommunication network. At step 304, the processor 104 may determine if the connection status of the user device is determined as the disconnected state or the connected state.

In case, at step 304, the connection status of the computing device 102 is determined as the connected state. The processor 104, at step 306, may dynamically determine the current location of the computing device 102 via, but not limited to, an assisted GPS. It may be noted that the current location of the computing device 102 may be determined by using other positioning systems and methodologies.

At step 308, the processor 104 may dynamically update the network coverage map based on the current location of the computing device 102 determined in step 306. It may be noted that the network coverage map may correspond to one or more telecommunication networks of which the computing device 102 may have an active subscription. The network coverage map may include a list of locations in which various bands of the telecommunication network that may be available at each of the locations. It may be noted that the steps 306 and 308 may be iteratively performed after a predefined time interval until the connection state of the computing device 102 is determined as the connected state at step 304. Further, the processor 104 may continue to monitor the connection state of the computing device 102 at step 302.

In case the connection status of the computing device 102 is determined as disconnected state, at step 304, the processor 104 may determine one or more locations having a signal strength of the telecommunication network above a predefined threshold based on a network coverage map of the telecommunication network at step 310. The one or more locations are determined in an area proximal to the current location of the computing device 102 determined at step 306. The area proximal to the current location of the computing device 102 may be determined based on a predefined radius from the current location.

At step 312, the processor 104 may select a desired location from the one or more locations based on a predefined criterion. In one embodiment, the predefined criterion may be selected by determining a nearest navigable distance from the current location. Accordingly, the desired location may be determined as a location from the one or more location that is at a smallest distance from the current location. In another embodiment, the predefined criterion may include a user selection of the desired location from the one or more locations.

After selecting the desired location at step 312, the processor 104 may output a set of instructions on an I/O device 108 of the computing device 102 prompting the user to navigate to the desired location at step 314. In an embodiment, the prompting may include providing a set of audio and/or visual instructions to the user to navigate to the desired location.

Thus, the disclosed method and system overcomes the technical problem users face when their smart devices are not disconnected from a telecommunication network. The methodology may allow the users to navigate to a nearest location that may have signal strength in order for the computing device 102 to be connected again to the telecommunication network.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

As will be appreciated by those skilled in the art, the techniques described in the various embodiments discussed above are not routine, or conventional, or well-understood in the art. The techniques discussed above prompt a user to navigate based on a connection to a telecommunication network.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described method and system for prompting a user to navigate based on a connection to a telecommunication network. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method for prompting a user to navigate based on connection to a telecommunication network, the method comprising:
determining, by a processor, a connection status of a user-device as one of: a connected state or a disconnected state, based on a connection of the user-device to the telecommunication network;
upon determining the connection status of the user-device as the disconnected state:
determining, by the processor, one or more locations having a signal strength of the telecommunication network above a predefined threshold based on a network coverage map of the telecommunication network,
wherein the one or more locations are determined in an area proximal to a current location of the user-device;
selecting, by the processor, a desired location from the one or more locations based on a predefined criterion; and
outputting, by the processor, a set of instructions on an output device of the user-device prompting the user to navigate to the desired location.

2. The method of claim 1, wherein the current location of the user-device is determined via a Global Positioning System (GPS) of the user-device upon determining the connection status of the user-device as the disconnected state.

3. The method of claim 1, further comprising:
upon determining the connection status of the user-device as the connected state:
dynamically determining, by the processor, the current location of the user-device via an assisted-GPS of the user-device; and
dynamically updating, by the processor, the network coverage map based on the current location of the user-device.

4. The method of claim 1, wherein the area proximal to the current location of the user-device is determined within a predefined radius from the current location.

5. The method of claim 1, wherein the predefined criterion comprises determining a nearest navigable distance from the current location.

6. The method of claim 1, wherein outputting the set of instructions comprises:
rendering, by the processor, a set of audio instructions prompting the user to navigate to the desired location.

7. A system for prompting a user to navigate based on a connection to a telecommunication network, the system comprising:
a processor;
a computer-readable medium communicatively coupled to the processor, wherein the computer-readable medium stores processor-executable instructions, which when executed by the processor, cause the processor to:
determine a connection status of a user device as one of: a connected state or a disconnected state, based on connection of the user device to the telecommunication network;
upon determining the connection status of the user-device as the disconnected state:
determine one or more locations having a signal strength of the telecommunication network above a predefined threshold based on a network coverage map of the telecommunication network,
wherein the one or more locations are determined in an area proximal to a current location of the user-device;
select a desired location from the one or more locations based on a predefined criterion; and
output a set of instructions on an output device of the user device prompting the user to navigate to the desired location.

8. The system of claim 7, wherein the current location of the user-device is determined via a Global Positioning System (GPS) of the user-device upon determining the connection status of the user-device as the disconnected state.

9. The system of claim 7, wherein upon determining the connection status of the user-device as the connected state, the processor-executable instructions, on execution, further cause the processor to:
dynamically determine the current location of the user-device via an assisted-GPS of the user-device; and
dynamically update the network coverage map based on the current location of the user-device.

10. The system of claim 7, wherein the area proximal to the current location of the user-device is determined within a predefined radius from the current location.

11. The system of claim 7, wherein the predefined criterion comprises determining a nearest navigable distance from the current location.

12. The system of claim 7, wherein the processor is configured to output the set of instructions by rendering a set of audio instructions to prompt the user to navigate to the desired location.

13. A non-transitory computer-readable medium storing computer-executable instructions for prompting a user to navigate based on connection to a telecommunication network, the computer-executable instructions configured for:
determining a connection status of a user-device as one of: a connected state or a disconnected state based on a connection of the user-device to the telecommunication network;
upon determining the connection status of the user-device as the disconnected state:
determining one or more locations having a signal strength of the telecommunication network above a predefined threshold based on a network coverage map of the telecommunication network,
wherein the one or more locations are determined in an area proximal to a current location of the user-device;
selecting a desired location from the one or more locations based on a predefined criterion; and
outputting a set of instructions on an output device of the user-device prompting the user to navigate to the desired location.

14. The non-transitory computer-readable medium of claim 13, wherein the current location of the user-device is determined via a Global Positioning System (GPS) of the user-device upon determining the connection status of the user-device as the disconnected state.

15. The non-transitory computer-readable medium of claim 13, wherein the computer-executable instructions are configured for:
upon determining the connection status of the user-device as the connected state:
dynamically determining the current location of the user-device via an assisted-GPS of the user-device; and
dynamically updating, the network coverage map based on the current location of the user-device.

16. The non-transitory computer-readable medium of claim 13, wherein the area proximal to the current location of the user-device is determined within a predefined radius from the current location.

17. The non-transitory computer-readable medium of claim 13, wherein the predefined criterion comprises determining a nearest navigable distance from the current location.

18. The non-transitory computer-readable medium of claim 13, wherein outputting the set of instructions comprises:
rendering a set of audio instructions prompting the user to navigate to the desired location.
